(19) United States
(12) Patent Application Publication
(10) Pub. No.: US 2008/0237140 A1
(43) Pub. Date: Oct. 2, 2008

(54) Fluid Phase Distribution Adjuster

(75) Inventors: Jon Liverud, Oslo (NO); Davoud Tayebi, Jar (NO); Bjornar Svingen, Stjordal (NO)

Correspondence Address: ANDRUS, SCEALES, STARKE & SAWALL, LLP, 100 EAST WISCONSIN AVENUE, SUITE 1100, MILWAUKEE, WI, 53202, US

(73) Assignees: KVAERNER PROCESS SYSTEMS A.S., Lysaker (NO); SINTEF ENERGIFORSKNING AS, Trondheim (NO)

(21) Appl. No.: 10/575,067

(22) PCT Filed: Oct. 6, 2004
(86) PCT No.: PCT/IB2004/003453

§ 371 Date: Jun. 17, 2008

(30) Foreign Application Priority Data
Oct. 11, 2003 (GB) 0323918.3

(51) Int. Cl. B01D 17/12; C02F 1/26

(52) U.S. Cl. 210/738; 210/702; 210/151

(57) ABSTRACT

A fluid phase distribution adjuster (10) comprises two or more tubes (14) arranged to provide a plurality of separate flow paths for fluid. Means are provided for generating a radial acceleration of fluid flowing through each tube so as to promote movement of at least one fluid phase towards or away from a wall of the tube. The adjuster can be used as a coalescer for increasing the size of droplets in a distributed fluid phase carried by a continuous fluid phase, or as a mixer for mixing fluid phases.

The present invention relates to devices and methods for adjusting the distribution of phases in a multi-phase fluid mixture. In particular, the invention relates to adjustment of droplet distribution in a multi-phase fluid flow stream. Embodiments of the invention include, but are not limited to a fluid phase coalescer and a mixer.

In many industrial fields, for example in process industries and in oil production, fluid streams are produced, which contain more than one fluid phase. For example, the fluid stream may contain one or more fluids in a liquid phase mixed with one or more other fluids in a gas phase. Alternatively, the stream may contain two or more fluids, each in a liquid phase. In many circumstances the mixture will contain a distributed phase within a continuous phase. The distributed phase will usually comprise droplets which are carried by the continuous phase fluid.

In oil production a typical process flow would contain a mixture of oil droplets in a water continuous phase. In some circumstances, depending on relative proportions of the phases and the conditions of temperature and pressure, the mixture may contain water droplets in an oil continuous phase. Another common mixed phase flow in oil and gas production processes has water droplets carried by a hydrocarbon gas.

There is often a need to extract a fluid phase from the mixture, requiring a separation process. A variety of methods exist for separating phases. For effective separation it is usually desirable that the average droplet size is as large as possible. When the droplet size is small, for example in a mist, there is a risk that the droplets will pass through the separation device without being separated. This can have undesirable consequences for the downstream processes. Small droplets may be created as a result of choking processes in fluid flow systems, as occur, for example, in valves and pressure reduction equipment. The shear forces generated by this type of equipment cause droplets to break up into smaller droplets. Clearly, therefore, coalescence of droplets to produce larger droplets upstream of the separator is desirable.

Another common requirement in industrial processes is to produce a mixture of two or more fluid phases from separate single phase sources. In such mixtures it is often desirable for the distributed phase to be distributed as homogeneously as possible within the continuous phase.

It is an aim of the present invention to provide a compact device for coalescing of liquid phase droplets carried in a gas stream or liquid phase droplets carried in a liquid stream.

It is a further aim to provide a device which can be installed directly into a process duct or pipeline.

It is a further aim to provide a device which may be used in association with process equipment to improve the efficiency of a separation process.

It is a further aim to provide a device which may be installed upstream of separation equipment to coalesce the distributed phase for improved separation in the separation equipment.

It is a further aim to provide a device which may be installed downstream of equipment that induces shear forces on the fluid, so as to decrease the effect of droplet break-up resulting from the shear forces.

It is a further aim to provide a device that may be used for mixing of fluid phases.

According to a first aspect of the present invention there is provided a fluid phase distribution adjuster comprising two or more tubes arranged to provide a plurality of separate flow paths for fluid, and means for generating a radial acceleration of fluid flowing through each flow path so as to promote movement of at least one fluid phase towards or away from a wall of the tube.

Preferably, the means for generating radial acceleration includes means for generating turbulence in the continuous phase. The means for generating turbulence may be surfaces of tubes or ducts defining the separate flow paths.

According to a second aspect of the present invention there is provided a coalescer for increasing droplet size of a distributed phase fluid carried by a continuous phase fluid of a process flow stream in a pipeline, the coalescer comprising:

a pipe for installation in the pipeline;

a plurality of tubes arranged within the pipe so as to divide the process flow stream into a plurality of separate flow paths through corresponding tubes; and

means for imparting a radial acceleration to the fluid flowing through each tube so as to promote coalescence of droplets as a result of movement of the droplets towards or away from a wall of the tube.

The distributed phase may comprise liquid droplets and the continuous phase may be another liquid or a gas.

It is an advantage that larger coalesced droplets allow easier separation of the phases in downstream equipment.

It is a farther advantage that by dividing the flow into separate flow paths, a larger number of smaller size (e.g. diameter) tubes can be used. When radial acceleration is imparted to a fluid, for example by imparting a rotational or tangential component of velocity, the acceleration is inversely proportional to the radius, and so is greatest at the smallest radius. By using a plurality of smaller diameter tubes a high acceleration can be imparted to all the fluid flowing through the tubes.

It is a further advantage that turbulence generated in the tubes causes an increase in the rate of collisions of the droplets of the first phase, thereby promoting coalescence. This is especially important for very small droplets which coalesce due to turbulent collisions to form larger droplets.

It is a further advantage that, when the distributed phase has a higher density than the continuous phase, radial acceleration causes the droplets to move towards the tube walls causing a gathering of droplets into a film at the walls as the fluid passes along the tube. Centrifugal forces arising from the radial acceleration of the continuous phase ensure that the film remains attached to the tube wall. The film thickness increases along the length of the tube as more droplets enter the film. When the fluid exits the tube, the film is stripped off the end of the tube wall in the form of large droplets.

It is a further advantage that, when the distributed phase has a lower density than the continuous phase, the droplets move towards the tube axis, promoting coalescence of droplets by increasing the frequency of droplet collisions. When the fluid exits the tube, the average droplet size has increased as a result of the increased collision coalescence.

In a preferred embodiment the means for imparting a radial acceleration comprises one or more longitudinal vanes arranged to impart a rotational motion to fluid passing through the tube. The vane may extend diametrically partly or completely across the tube and be twisted to form a helix along the axis of the tube. Alternatively, one or more pairs of diametrically opposed vanes may be provided, each vane extending radially inwardly from the wall of the tube part way towards the tube axis.

Each tube may have a circular or non-circular cross-section. In embodiments having a non-circular cross-section the entire tube may be helically twisted about the longitudinal axis so that the walls of the tube impart a rotational motion to fluid passing through the tube. The non-circular section may be a square or other suitable geometry.

In a preferred embodiment, the spaces between adjacent tubes and between tubes and the pipe wall are sealed to ensure that all flow passes through the tubes.

The pipe may be of a predetermined or standard diameter. The diameter may be the same as that of the pipeleine. It is an advantage that the coalescer can be installed into a process pipeline, without requiring any increase in pipe diameter.

The coalescer may incorporate features that utilise further advantageous effects. The tubes may be arranged such that the hydraulic diameter of each tube is reduced as far as practically possible. It is an advantage that this maximises the centrifugal acceleration (which is inversely proportional to radius) without increasing the axial velocity, as well as increasing turbulence.

In a preferred embodiment, the tubes are parallel tubes closely packed to form a compact bundle. An advantage of this arrangement is that coalescence can be optimised by providing the largest possible number of tubes of a given diameter in a coalescer device of given overall dimensions.

In a preferred embodiment, the tubes have an area averaged hydraulic diameter, Dₕ* of 10 to 100 mm.

Preferably, the ratio: L_{f}*/Dₕ* is 50 to 200 for water continuous flow and 10 to 100 for oil continuous flow. More preferably, design values are about 110 and 30 respectively.

According to a third aspect of the present invention there is provided a mixer for mixing a first fluid as droplets of a distributed phase within a continuous phase fluid of a process flow stream in a pipeline, the mixer comprising:

a pipe for installation in the pipeline;

a plurality of tubes arranged within the pipe so as to divide the process flow stream into a plurality of separate flow paths through corresponding tubes;

inlet means for introducing the first fluid phase as droplets into each tube; and

means for imparting a radial acceleration to the fluid flowing through each tube so as to distribute the droplets in the process flow stream.

In a preferred embodiment, the inlet means comprises a plurality of openings in the wall of each tube, the means for imparting a radial acceleration promoting movement of the droplets away from the tube wall.

Preferably, the openings are each of a size such that the first phase enters the second phase by droplets being torn away from the openings by momentum of the flow of the second phase.

The means for generating radial acceleration may include means for generating turbulence of the continuous phase. The turbulence may be generated in an entrance region of the duct. It is an advantage that the random nature of turbulence causes a dispersion of the droplets within the continuous phase.

In embodiments of all aspects of the invention, the number, length and diameter of the tubes, as well as the means for generating radial acceleration are selected to provide fluid velocities and turbulence intensities so that desired effects of droplet coalescence or mixing are produced for a given fluid mixture composition, physical properties and flow rate.

Embodiments of the invention are described below with reference to the accompanying drawings, in which:

FIG. 1 depicts a fluid phase distribution adjuster;

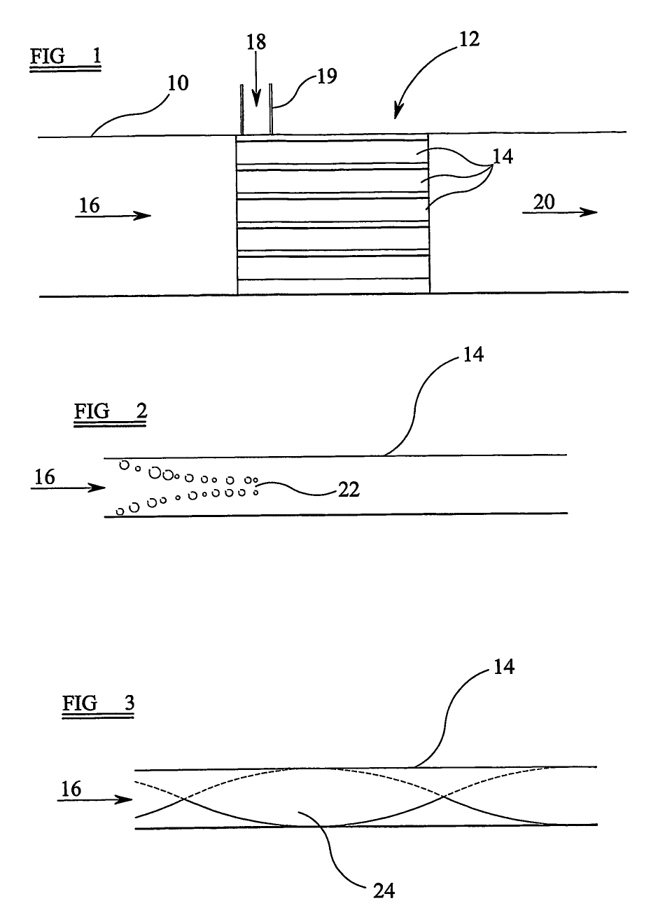

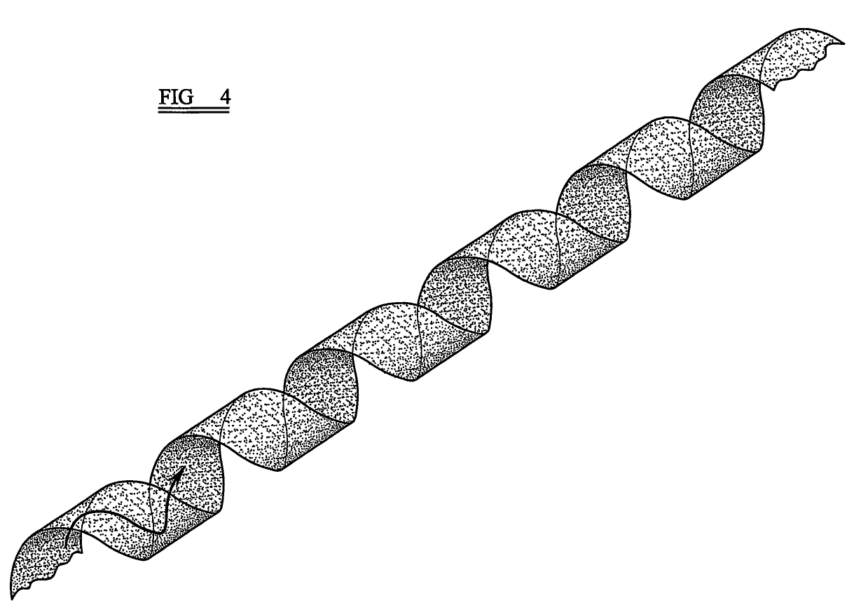

FIG. 2 illustrates aspects of fluid flow within one duct of the adjuster of FIG. 1;

FIGS. 3a and 3b depict two examples of a duct forming part of the adjuster of FIG. 1, when used as a coalescer;

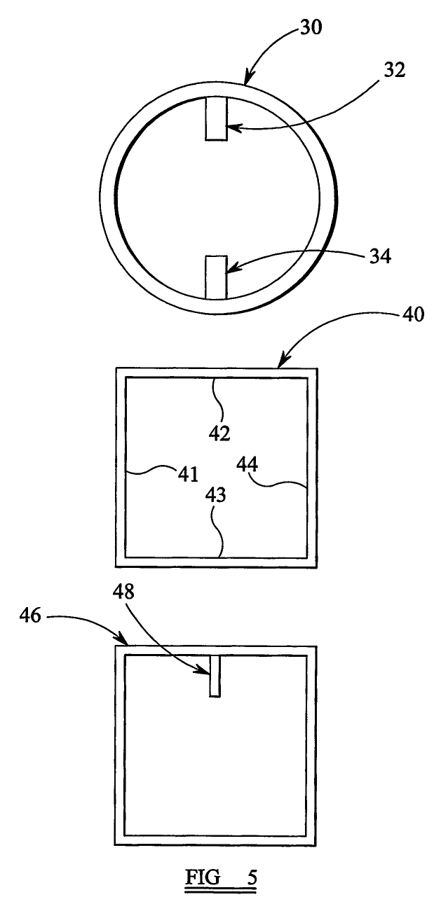

FIG. 4 illustrates a flow path for fluid through the duct of FIG. 3a;

FIG. 5 shows cross-sections of a variety of alternative duct geometries suitable for use in the adjuster of FIG. 1, when used as a coalescer;

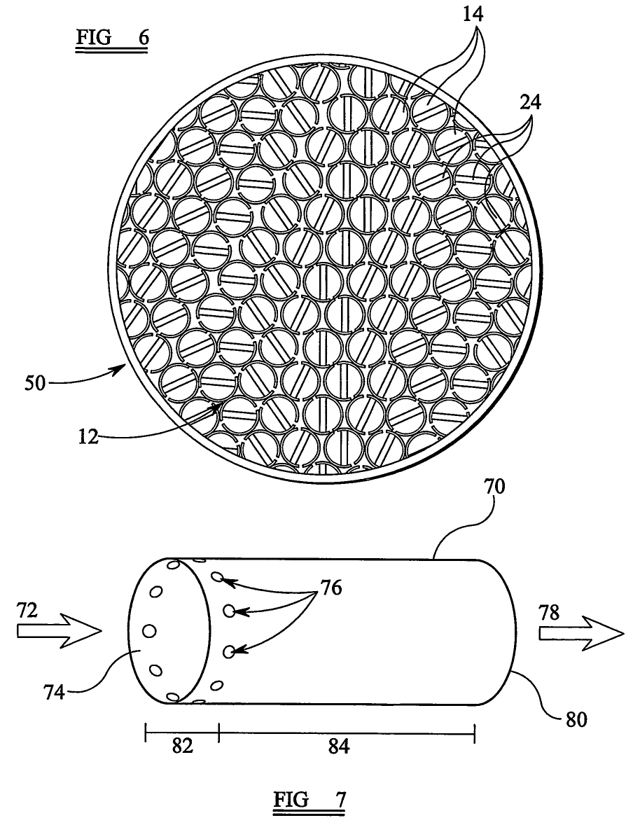

FIG. 6 depicts a tube packing arrangement for use in the adjuster of FIG. 1, when used as a coalescer;

FIG. 7 depicts a tubular duct for use in the adjuster of FIG. 1, when used as a mixer;

FIG. 8 is an illustration of a gas scrubber incorporating an adjuster; and

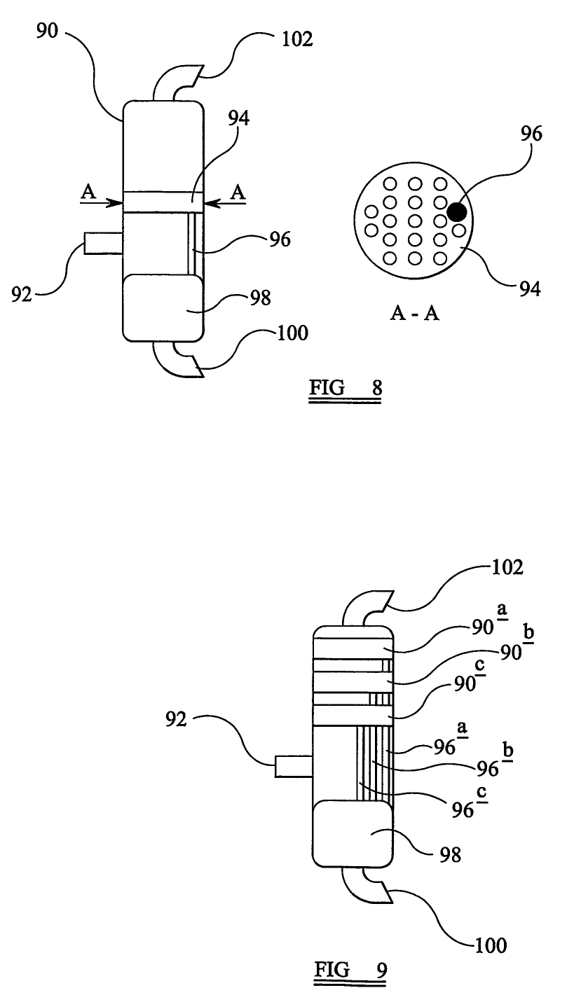

FIG. 9 is an illustration of a gas scrubber incorporating a plurality of adjusters.

Referring to FIG. 1, a fluid phase distribution adjuster 10 is arranged in a flow stream 16 of a process fluid. The adjuster has a bundle 12 of parallel tubes 14, axially aligned in the direction of flow of the flow stream 16. The bundle 12 extends across the entire flow stream 16 so that the flow stream is divided into a plurality of parallel fluid paths through each of the tubes 14.

The adjuster may be used as a coalescer for coalescing droplets of a distributed fluid phase carried by a continuous fluid phase in the process flow stream 16. The fluids exit the adjuster 10 as an adjusted flow stream 20 in which the volumes of each phase remain unchanged, but the distributed phase droplets have been coalesced to form larger droplets.

Alternatively, the adjuster may be used as a mixer for mixing fluid phases. In this case the process flow stream 16 comprises a first continuous fluid phase, and a separate inlet 19 is provided for a second fluid phase. The inlet 19 delivers the second fluid phase to openings (not shown) close to the inlet end of each of the tubes 14.

When operating as a coalescer the inlet 19 is omitted and the adjuster 10 provides for radial acceleration of the individual flow paths (i.e. in a transverse direction normal to the axial flow direction). This acceleration has a different effect on the motion of each of the phases, according to their relative densities. As a result, the droplets of the distributed phase migrate in a different transverse direction to the continuous phase fluid, and so are brought closer together. This has the effect of increasing the likelihood of droplets colliding with each other and coalescing.

In one embodiment, as shown in FIG. 2, the radial acceleration is caused by an increase in the turbulence of the flow stream 16 as it enters the tube 14 as shown at 22. Turbulence is important for increasing the frequency of droplet collisions, especially for very small (e.g. less than 10 micron diameter) droplets.

In another preferred embodiment, referred to as a centrifugal tube coalescer (CTC), radial acceleration is also provided by a rotational motion imparted to the fluid as it flows through the duct. This may be achieved with the tube 14 shown in FIG. 3. The tube 14 has a circular cross-section and includes a longitudinal vane 24 extending diametrically across the tube and twisted to form a helix along the axis of the tube. As fluid flows through the tube 14, the vane 24 imparts a rotational motion thereby generating a radial acceleration of the fluid. The bulk motion of fluid flowing through one half of the tube 14 is shown in FIG. 4. This shows that a rotational component of velocity is imparted to the flow.

A variety of tube cross-section geometries may be used to obtain the effect described above. FIG. 5 illustrates three alternative geometries. A circular tube duct 30 includes a pair of diametrically opposed vanes 32, 34, each vane extending radially inwardly from the wall 36 of the tube part way towards the tube axis. The vanes 32, 34 are each twisted in a helical pattern along the tube length in a similar manner to the vane shown in FIG. 3. Alternatively, one or other of the vanes 32, 34 may be omitted, and the remaining vane may extend across the tube to beyond the axis. A square section tube 40 has no vane, but the entire cross-section is helically twisted along the length of the duct so that the walls 41, 42, 43, 44 of the tube impart a rotational motion to fluid passing through the tube 40. A similar helically twisted square section tube 46 includes a longitudinal vane 48 extending part way across the tube.

Alternatively, any non-circular cross-section tube may be used, in which the tube is helically twisted about the axis so that the walls impart a rotational motion to fluid passing through the tube.

In order to optimise the cross-sectional area for flow through the tubes 14 for a given overall size of adjuster 10 (determined by the size of the tube bundle 12) it is preferred to use circular cross-section tubes. FIG. 6 illustrates a bank 12 of tubes 14, each tube having a longitudinal helically twisted baffle 24, arranged across the internal cross-section of a circular pipe 50. The pipe 50 may be a standard size of industrial process pipe and may have flanges or other suitable connection means for installation into an industrial fluid flow process pipeline.

The principal design considerations for the CTC are to construct a device that will increase droplet size in a fluid flow. The device consists of small hydraulic diameter tubes arranged in a parallel array in which an axial and rotational motion is imparted to the fluid in each of the tubes.

There are 5 principal features:
1. To use the centrifugal field set up by the spinning motion of the continuum fluid to make droplets coalesce to the wall (density of droplet larger than density of continuum fluid) or coalesce to each other (density of droplet smaller than the density of continuum fluid).
2. To decrease the hydraulic diameter of the tube in which the fluid is spinning as much as practically possible to:
   a. maximize the centrifugal accelerational field given by a=(U_{tangential})²/r without increase in velocity and
   b. to increase the ratio of droplet motion due to turbulence relative to the tube hydraulic diameter so as to increase the statistical possibility for turbulence enhanced coalescing through collisions of suspended droplets.
3. To use the centrifugal field to hold droplets on the wall and to prevent breakup of the film. Thus, the coalescing force may be centrifugal force or turbulence.
4. To have a long length to hydraulic diameter ratio to provide a long relative settling time and a short relative settling distance.
5. To use several small hydraulic diameter coalescing tubes in parallel to maintain the above features even for large volumetric flow rates.
   The table below contains definitions of the symbols used in the discussion of the CTC design that follows.

| Letter | Meaning | Unit |
|---|---|---|
| K₁ | ${K}_{1} design factor \text{/} parameter {K}_{1} = {U}_{c} \sqrt{\frac{{ρ}_{c}}{{ρ}_{d} - {ρ}_{c}}}$ | [m/s] |
| ρ_{c} | Density of continous phase | [kg/m³] |
| ρ_{d} | Density of dispersed phase (droplets) | |
| U_{c} | Bulk velocity in each pipe, U_{ci} = Qᵢ/Aᵢ | [m/s] |
| K₂ | ${K}_{2 } design facor \text{/} parameter \text{:} {K}_{2} = \frac{{K}_{1}}{cos ( α )}$ | [m/s] |
| α | Angle between the baffle(s) and the longitudinal | [degrees] |
| | direction of the tube | |
| D | Diameter | [m] or [mm] |
| r | Radius | [m] or [mm] |
| * | Area averaged | [−] |
| i | Subscript denoting each pipe | [−] |
| f | Friction factor | [−] |
| A | Area | [m²] |
| L | Length of each pipe | [m] |
| n | Number of pipes in one CTC | [−] |
| aₙ | Tube number function | [s/m³] |
| L_{dm}* | Droplet mixing zone | [m] |

### 1 Gas-Liquid Centrifugal Tube Coalescer (CTC)

A gas-liquid CTC for mist (gas with droplets of liquids and with liquid droplet contents of 1 vol % or less) will preferably have tubes with a relatively small hydraulic diameter and a large length to diameter ratio.

The main design factor is called the “K-factor”, commonly used when designing demisters and demisting equipment. The K-factor is defined as:

$${K}_{1} = {U}_{c} \sqrt{\frac{{ρ}_{c}}{{ρ}_{d} - {ρ}_{c}}}$$

and has the unit m/s. U_{c} is the “bulk” velocity of the gas flowing through each tube of the CTC at design condition, and is thus defined as the volumetric rate of gas flowing through each tube divided by the cross sectional area of the tube. The CTC consist of several tubes in parallel, and an area averaged K factor is therefore more appropriate to use and is defined as:

$${K}_{1}^{*} = \frac{1}{{A}_{tot}} {\sum }_{i = 1}^{n} {K}_{1 i} {A}_{i}$$

where Aₜₒₜ is the sum of the cross sectional area of all the pipes and n is the number of pipes,

$${A}_{tot} = {\sum }_{i = 1}^{n} {A}_{i} .$$

For the gas-liquid CTC to work properly the area averaged K-factor, K₁*, must be below 5 m/s with a preferable range of 0.05 to 2.0 m/s and a design value of 0.6 m/s.

Another closely related design factor for the CTC is the K₂-factor. The K₂-factor is defined as:

$${K}_{2} = {U}_{actual} \sqrt{\frac{{ρ}_{c}}{{ρ}_{d} - {ρ}_{c}}}$$

and has the unit m/s. U_{actual} is the “actual bulk velocity” of the gas in each tube of the CTC, and is defined as the bulk velocity, U_{c}, devided by the cosine of the angle between the baffle(s) and the longitudinal core line (axis) of the CTC. The area averaged K2 factor is defined as:

$${K}_{2}^{*} = \frac{1}{{A}_{tot}} {\sum }_{i = 1}^{n} {K}_{2 i} {A}_{i}$$

For a properly functioning CTC, the K₂* factor must be larger or equal to the K₁* factor with a preferable design value of K₂=K₁*\sqrt{2}.

Thus the K₁* factor and the K₂* factor define the angle between the baffle(s) and the longitudinal axis of the CTC; α=a cos(K₁*/K₂*), the preferred value of α being 45 degrees.

The diameter of each pipe in the CTC should be described by the hydraulic diameter defined as:

Dₕ=4A/O

where A is the cross sectional area of each tube and O is the wetted perimeter of each tube. The area averaged hydraulic diameter is thus:

$${D}_{h}^{*} = \frac{1}{{A}_{tot}} {\sum }_{i = 1}^{n} {D}_{hi} {A}_{i}$$

The diameter of each tube should ideally be as small as possible and is constrained only by practical limitations such as manufacturing and operational parameters. The preferable range of hydraulic diameter is below 50 mm for the gas-liquid CTC (ideally 5-30 mm).

The length to diameter ratio for the tubes is determined by two main factors:
1. The droplets must have enough time to go from the midle of each tube to the wall, under the imparted centrifugal acceleration.
2. The smallest droplets (smaller than 10 micron and submicron range) must have a substantial statistical possibility, governed by turbulent fluctuations, of coalescing to form larger droplets and hitting the wall during the time they are inside the tube.

The first factor is mainly decided by the designer according to practical considerations. The design factor is the area averaged flow length path, L_{f}*, divided by the area averaged hydraulic diameter, Dₕ*. The flow length path is defined as the length of each pipe divided by the cosine of the angle between the baffle(s) and the longitudinal axis of the CTC: L_{f}=L/cos(α).

For a tube (or in general a constrained internal flow) the largest turbulent length scale is smaller or equal to the hydraulic diameter. The turbulence intensity in percentage of the bulk velocity is typically in the order of 2-10% in tubes, but can readely be approximated by: 0.16Re_{Dh}^{-1/8}. For a CTC that will coalesce submicron droplets, the length of each tube must therefore be long enough so that a droplet can go from the middle of the tube to the wall following the turbulent fluctuations within the time it takes for the droplet to pass through the tube. Statistically this will only happened when the ratio L_{f}*/Dₕ* is greater than or equal to 5, where L_{f}* is defined as:

$${L}_{f}^{*} = \frac{1}{{A}_{tot}} {\sum }_{i = 1}^{n} \frac{{L}_{i}}{cos ( {α}_{i} )} {A}_{i}$$

The preferred ratio, L_{f}*/Dₕ* is 34, but can be any value in excess of about 5. The upper limit is constrained only by practical considerations and pressure drop.

The importance of turbulence in coalescing very small droplets may be seen by considering a Computational Fluid Dynamics (CFD) simulation of flow in a straight tube without any vanes, starting with a situation in which there are no droplets in the tube. As flow through the tube proceeds, very small (sub-micron) droplets start to emerge inside the tube, similar to a build up of mist. The mist then evolves into larger droplets due to turbulent coalescing.

CFD simulations show that for a tube of 10 mm diameter and 200 mm long (L/D=20), and an initial turbulence intensity of 5%, the percentage of droplets hitting the wall due to turbulence may be predicted by

57 K₁^{-0.17}

The maximum value is 100% (corresponding to K₁ of 0.0366). For a K₁ value of 10 (which is higher than would be expected for most situations) the percentage drops to about 40%. Fully developed turbulent flow requires an LID ratio of 18-30 for Reynolds numbers of 10⁴-10⁵. Thus efficient coalescing of the smallest droplets due to turbulence can be achieved with tubes having an L/D of 20 or more.

For a typical gas-liquid CTC the coalescing of all droplets smaller than 1-10 microns occurs due to turbulence, with more than 60% of the smallest droplets being coalesced. This means that it is the L/D ratio and small diameter which causes the coalescing, while centrifugal forces generated by the vanes serve to keep the film in place on the tube wall. For larger droplets the centrifugal forces cause the coalescing by forcing the droplets towards the tube wall.

The packing of the tubes is essential for proper operation. The packing is linked to the K₁* factor. Since the idea of the CTC is to coalesce small droplets into larger droplets in a stream, the CTC will have to be constrained to a limited projected area normal to the axial direction, and it will have to have a defined inlet and a defined outlet. This means that a K factor at the inlet of the CTC (on the projected area normal to the axial direction) can be related to the area averaged K₁* factor of the CTC, which again can be related to the number of tubes in the CTC. The K factor at the inlet is defined as K₀:

$${K}_{0} = \frac{{Q}_{0}}{{A}_{0}} \sqrt{\frac{{ρ}_{c}}{{ρ}_{d} - {ρ}_{c}}}$$

It is further neccesary to define a mean area for all the tubes in the CTC which is:

$${A}_{mean} = \frac{1}{n} {\sum }_{i = 1}^{n} {A}_{i} = \frac{{A}_{tot}}{n}$$

Thus the total area of the tubes in the CTC is described as the mean area of the tubes multiplied by the number of tubes. The number of tubes for the CTC can now be defined as:

$$n = \frac{{K}_{0}}{{K}_{1}^{*}} \frac{{A}_{0}}{{A}_{mean}}$$

where K₀ and A₀ are constants not directly tied to the CTC, but also dependant on the constraints in which the CTC will operate (actual dimensions of system, flow rates, etc.) which may or may not be changeable. Due to geometric conditions, A₀ must be larger than Aₜₒₜ, and K₀ must be smaller than K₁*. Thus the number of pipes is described by:

n=αₙK₀A₀

where the factor an has the unit s/m³. The preferred value of an is between 850 to 85000 and 21220 is a suitable value for 10 mm diameter tubes. However, aₙ can be within the range of 25 to 1.3e8. In addition, n must be larger than 1.

### 2 Liquid-Liquid CTC

The principles of the liquid-liquid CTC are basically an extension of those for the gas-liquid CTC; the coalescing forces are a combination of centrifugal forces and stochastic turbulence. There is one major difference where the densest phase is continuous and in which lower density droplets will migrate to the centre of the tubes instead of migrating to the wall. In oil production processes this is known as “water continuous flow”—i.e. oil. droplets carried in water—whereas flow of water droplets carried in oil is known as “oil continuous flow”. When migrating to the centre, in some designs coalescing may occur due to increased droplet concentration and thus increased statistical possibility for droplet-droplet collision. Theoretically this is not straightforward to calculate since droplet migration to the centre does not necessarily result in coalescing. Initial droplet concentration is therefore also important. K-factors, as used with gas-liquid demisting, are not usually used in liquid-liquid applications. Instead settling time and velocities are used. The differences in the velocities of the continuum liquid and the droplets are very small in a liquid-liquid CTC when compared with a gas-liquid CTC. This means that droplets migrating to the wall do not necessarily form a film on the wall (as in the gas-liquid CTC), but remain as droplets that are carried through the tube in a region close to the wall.

For the liquid-liquid CTC it is therefore more correct to describe the performance in terms of concentration of droplets. The fluid has a homogenous concentration distribution across the inlet cross sectional area, but has a non-homogenous concentration across the outlet cross sectional area. This non-homogenous concentration (i.e higher concentration of droplets in certain sub-areas), of the outlet will increase the possibility of droplets coalescing and the end result will be the same as for the gas-liquid CTC. That is to say there will be an increase in average droplet diameter at the outlet compared with the inlet. However, the statistical possibility of coalescing is dependent on the actual droplet number density (number of droplets per unit volume of continuum liquid).

The performance characteristics will be different for a water continuous CTC than for an oil continuous CTC, because of the different migration directions of droplets for the two different CTCs. An oil continuous CTC will have better coalescing performance in terms of centrifugal coalescing and turbulent coalescing, while a water continuous CTC will have larger droplets exiting the CTC. For a preferred water continuous design, about 20-30 percent of all droplets below approximately 300-500 micron are assumed coalesced regardless of size, while larger droplets are coalesced with increasing performance for increasing droplet size, but dependent on the initial droplet number density. For the oil continuous CTC, approximately 85 percent of all droplets are assumed coalesced regardless of size, but again dependant on initial droplet number density. The droplet size out of the CTC is very dependent on the velocity. While increased velocity will increase the coalescing performance of each tube, increased velocity will also tend to break up droplets at the exit. The various design parameters need to be considered carefully in order to balance these conflicting effects.

Since the K-factor is not a practical parameter for the design of a liquid-liquid CTC, the velocity is used instead. As defined for the gas-liquid CTC the relationship between U_{c}* and U_{actual}* is such that U_{actual}* must be larger than U_{c}* and preferably such that the design value of U_{actual}* is \sqrt{2} U_{c} (the star refers to the area averaged velocity). U_{c}* should be larger than 0.1 m/s and smaller than 7 m/s, and preferably within the range of 0.5 to 5 m/s. For an oil continuous CTC, the maximum should be kept lower than 2-3 m/s.

The area averaged hydraulic diameter, Dₕ* should preferably be 10 to 100 mm and is limited downward by practical considerations.

The ratio: L_{f}*/Dₕ* should preferably be 50 to 200 for water continuous flow and 10 to 100 for oil continuous flow. Design values should aim for 110 and 30 respectively and are limited upward by practical considerations.

The number of tubes, n, within the area A₀ is defined as:

n=αₙU₀A₀

n must be larger than 1. Also, an should preferably be within the ranges 60-6400 for water continuous and 130-13000 for oil continuous. For most practical considerations, n is determined when design values of Dₕ* and U₁* are chosen.

Referring now to FIG. 7, a tube 70 is shown for an adjuster used as a fluid phase mixer. A first fluid phase 72 flows into a tube inlet 74 as described above for FIG. 1. A series of small holes 76 are distributed around the tube circumference a short distance from the inlet 74. These holes provide a second inlet for a second fluid phase. Mixed fluid 78 exits the tube 70 through an outlet 80.

There are basically two different mixing properties, one is turbulent mixing and one is mixing due to velocity differences between droplets of the second fluid phase and the first fluid phase. When mixing, it is generally preferable to produce as small droplets as possible and to distribute those droplets evenly in the main fluid. In the mixer described herein small droplets are produced when the second fluid phase enters the first fluid phase through the holes 76. This occurs in a droplet break-up zone 82 close to the inlet holes 76. Turbulence in each tube 70 distributes those small droplets throughout the first fluid phase. By using relatively small diameter tubes, the mixer can be made very compact.

The tubes 70 in the mixer are mounted in a tube bundle 12 as shown in FIG. 1, so that the space between the tubes is closed (sealed) at each end of the tube bundle 12. This sealed space provides a flow passage for the second fluid phase. The relative velocity between the fluid phases tears the second fluid phase into small droplets. The region following the droplet break-up zone is a droplet mixing zone 84. Turbulence in the droplet mixing zone 8 distributes the droplets evenly in the first fluid phase. Short baffles (not shown) may be provided near the tube outlet 80 to increase turbulence and provide further mixing of droplets.

Note that turbulence has a different effect on the droplet distribution in the mixer from that in the coalescer. In both cases the turbulence imparts a (random) radial acceleration to the droplets. In the mixer, the droplets originate from a point and it is the random nature of the turbulent flow in the entry region of the tube that causes droplet dispersion. By contrast, in the coalescer, the droplets start by being dispersed and the random nature of the turbulence increases the frequency of collisions to coalesce droplets.

The main design parameter for the mixer is U_{c}*. Droplet size is directly proportional to U_{c}* and to produce a droplet diameter less than 10 micron, a value of 5 m/s should preferably be used for most fluids. However dependent of the actual droplet size needed/wanted, U_{c}* can take any value only limited upwards by pressure drop and possibilities of erosion.

The area averaged hydraulic diameter, Dₕ* should preferably be 10 to 100 mm and is limited downward by practical considerations.

The ratio: L_{dm}*/Dₕ* should preferably be between 2 to 20, with an ideal design value of about 10, where L_{dm}* is the length of the droplet mixing zone.

The number of tubes, n, within the area A₀ is defined as:

n=αₙU₀A₀

n must be larger than 1. Preferably, an should be within the range 25-2500. However, for most practical considerations, n is determined when design values of Dₕ* and U₁* are chosen.

The holes in each tube should number 2 or more and should be evenly distributed round the periphery and positioned so that the length of tube from the holes to the exit of each tube constitutes the length of the droplet mixing zone.

Referring to FIGS. 8 and 9, one application of the gas-liquid CTC is for use in a scrubber. The basic concept is shown in FIG. 8. A mixed phase fluid enters a scrubber vessel 90 through an inlet 92. A bank of coalescing tubes 94 are packed so that the K₁* factor is approximately 0.6. These are positioned in the scrubber vessel 90 which has a K₀ factor of about 0.1-0.2. Droplets are coalesced in the tubes 94 and are carried through the tubes by the relatively high fluid velocities in the tubes. The droplets are blown off the ends of the tubes and fall back as the fluid velocities drop, to be collected and drained down by gravity through a downcomer 96 to a liquid collector 98 and liquid outlet 100. The gas phase exits the scrubber vessel 90 through an outlet 102.

As shown in FIG. 9, several banks of coalescing tubes 90a, 90b, 90c can be stacked on top of each other for improved performance. Each bank of tubes has an associated downcomer 96a, 96b, 96c. The pressure drop of each bank of tubes is typically 100-600 Pa dependent on the design. This means that theoretically 10-20 banks of coalescer tubes can be installed in one vessel for a similar pressure drop to that of demisting equipment of known technology. For practical purposes, 2-4 banks of tubes would probably be adequate. Compared with known technology, for instance multi-cyclone scrubbers, the CTC scrubber has the advantage of also being able to separate sub-micron size droplets. Each bank of coalescer tubes will typically be able to separate 40-45% of the sub-micron droplets. This means that after one bank 60% of sub-micron droplets remain, after two banks 36% remain, after three banks 22% remains and so on.

1-12. (canceled)

13. A coalescer for increasing droplet size of a distributed phase fluid carried by a continuous phase fluid of a process flow stream in a pipeline, the coalescer comprising:
a pipe for installation in the pipeline;
a plurality of tubes arranged within the pipe so as to divide the process flow stream into a plurality of separate flow paths through corresponding tubes; and
means for imparting a radial acceleration to the fluid flowing through each tube so as to promote coalescence of droplets as a result of movement of the droplets towards or away from a wall of the tube.

14. A coalescer according to claim 13, configured to promote coalescence of a distributed phase comprising liquid droplets in a continuous phase comprising another liquid or a gas.

15. A coalescer according to claim 13, wherein the means for generating a radial acceleration comprises one or more longitudinal vanes extending partially or completely across the tube and twisted to form a helix along the axis of the tube so as to impart a rotational motion to fluid passing through the tube.

16. A coalescer according to claim 13, wherein each tube is of non-circular cross-section and is helically twisted about the longitudinal axis so that the walls of the tube impart a rotational motion to fluid passing through the tube.

17. A coalescer according to claim 13, wherein the means for generating radial acceleration includes means for generating turbulence in the continuous phase.

18. A coalescer according to claim 13, wherein the number, length and diameter of the tubes, as well as the means for generating radial acceleration are selected to provide fluid velocities and turbulence intensities so that desired effects of droplet coalescence or mixing are produced for a given fluid mixture composition, physical properties and flow rate.

19. A coalescer according to claim 1, wherein the tubes have an area averaged hydraulic diameter, Dₕ* of 10 to 100 mm.

20. A coalescer according to claim 13, wherein the ratio L_{f}*/Dₕ* (the area averaged flow length path L_{f}* to the area averaged hydraulic diameter Dₕ*) is 50 to 200 and more preferably has a design value of about 110 for water continuous flow, whereas L_{f}*/Dₕ* is 10 to 100 and more preferably has a design value of about 30 for oil continuous flow.

21. A mixer for mixing a first fluid as droplets of a distributed phase within a continuous phase fluid of a process flow stream in a pipeline, the mixer comprising:
a pipe for installation in the pipeline;
a plurality of tubes arranged within the pipe so as to divide the process flow stream into a plurality of separate flow paths through corresponding tubes;
inlet means for introducing the first fluid phase as droplets into each tube; and
means for imparting a radial acceleration to the fluid flowing through each tube so as to distribute the droplets in the process flow stream.

22. A mixer according to claim 21, wherein the number, length and diameter of the tubes, as well as the means for generating radial acceleration are selected to provide fluid velocities and turbulence intensities so that desired effects of droplet coalescence or mixing are produced for a given fluid mixture composition, physical properties and flow rate.

23. A mixer according to claim 21, wherein the tubes have an area averaged hydraulic diameter, Dₕ* of 10 to 100 mm.

24. A mixer according to claim 21, wherein the ratio L_{f}*/Dₕ* (the area averaged flow length path L_{f}* to the area averaged hydraulic diameter Dₕ*) is 50 to 200 and more preferably has a design value of about 110 for water continuous flow, whereas L_{f}*/Dₕ* is 10 to 100 and more preferably has a design value of about 30 for oil continuous flow.

25. A fluid phase distribution adjuster comprising two or more tubes arranged to provide a plurality of separate flow paths for fluid, and means for generating a radial acceleration of fluid flowing through each tube so as to promote movement of at least one fluid phase towards or away from a wall of the tube.

26. A fluid phase distribution adjuster according to claim 25, wherein the means for generating radial acceleration includes means for generating turbulence in the continuous phase.

27. A fluid phase distribution adjuster according to claim 25, wherein the number, length and diameter of the tubes, as well as the means for generating radial acceleration are selected to provide fluid velocities and turbulence intensities so that desired effects of droplet coalescence or mixing are produced for a given fluid mixture composition, physical properties and flow rate.

28. A fluid phase distribution adjuster according to claim 25, wherein the tubes have an area averaged hydraulic diameter, Dₕ* of 10 to 100 mm.

29. A fluid phase distribution adjuster according to claim 25, wherein the ratio L_{f}*/Dₕ* (the area averaged flow length path L_{f}* to the area averaged hydraulic diameter Dₕ*) is 50 to 200 and more preferably has a design value of about 110 for water continuous flow, whereas L_{f}*/Dₕ* is 10 to 100 and more preferably has a design value of about 30 for oil continuous flow.

30. A process for coalescing droplets of a distributed phase fluid carried by a continuous phase fluid of a process flow stream, the process comprising:
causing the process flow stream to flow into a coalescer unit comprising a plurality of tubes;
dividing the process flow stream into a plurality of separate flow paths through corresponding tubes; and
imparting a radial acceleration to the fluid flowing through each tube so as to promote coalescence of droplets as a result of movement of the droplets towards or away from a wall of the tube.

31. A process for mixing a first fluid as droplets of a distributed phase within a continuous phase fluid of a process flow stream, the process comprising:
causing the process flow stream to flow into a mixer unit comprising a plurality of tubes;
dividing the process flow stream into a plurality of separate flow paths through corresponding tubes;
introducing the first fluid phase as droplets into each tube; and
imparting a radial acceleration to the fluid flowing through each tube so as to distribute the droplets in the process flow stream.
